(19) United States
(12) Patent Application Publication
(10) Pub. No.: US 2007/0286419 A1
(43) Pub. Date: Dec. 13, 2007

(54) Efficient Video Delivery in Legacy 802.11 Infrastructure Enviroments

(76) Inventors: Dmitri Varsanofiev, San Diego, CA (US); Alexander Tesler, Palo Alto, CA (US); Alexander Pevzner, Moscow (RU)

Correspondence Address: ALEXANDER TESLER, 3731 MIDDLEFIELD ROAD, PALO ALTO, CA, 94303-4715, US

(21) Appl. No.: 11/422,599

(22) Filed: Jun. 7, 2006

(51) Int. Cl. H04N 7/167

(52) U.S. Cl. 380/201

(57) ABSTRACT

The invention describes a method of efficient way of video delivery in the legacy (non-802.11e) infrastructure networks and a device (Transmitter) based on this method. The invention permits the video stream to bypass the access point and therefore increases the available bandwidth by a factor of two or more and permits increasing the throughput by improving only the radio and antenna on the Transmitter (as opposed to improvements on both the Transmitter and AP necessary without the invention).

A typical wireless network setup at home includes an access point (AP). All wireless transmissions between two stations (STA) are routed through this AP. Since both the uplink (STA to AP) and downlink (AP to STA) transmissions use the same radio channel, the effective bandwidth is at best half of the potentially available for the STA-to-STA direct communication. The available bandwidth is also limited by a weaker AP-STA link, and, therefore, improving the radio and antenna on one of the STA does not help much.

Typical scenario of a wireless video installation at home involves adding a new video transmitter to the existing network and using an existing laptop as a video receiver. It is therefore very beneficial to be able to transmit video bypassing the AP. The new WLAN standard, 802.11e, includes features that allow such bypass, Direct Link Protocol and Local Multicast. However, these features are optional, and the installed base of APs does not have them.

A direct STA-to-STA communication is also available in the so called Ad-Hoc or IBSS configuration of the WLAN, but IBSS is rarely used in the home environment. This invention describes a way to deliver video from one STA to another in a “legacy infrastructure” configuration (using an existing pre-802.11e AP).

The invention utilizes features of few popular home WLAN configurations and the video stream:
Home WLAN typically uses only three types of encryption: None, WEP, WPA-PSK, the latter using either TKIP or CCMP crypto suites
Video stream comes as a high-bandwidth continuous stream of data frames

This invention describes two ways to send video from one STA (Transmitter) to another one (Receiver), while bypassing the AP.

In the first one, the Transmitter sends the video using a key shared between the Transmitter and Receiver via means out of scope of this invention, and unknown to the AP. Since AP cannot decrypt these messages, it does not retransmit them. This approach is possible with most AP installations. Although it is theoretically possible that an AP will retransmit the received multicast frames in the case of no encryption, it does not happen in practice. This approach will work with all three types of encryption typically used at home, by using the unused WEP key slots and WPA group key slots.

The second way is for the Transmitter to send unicast frames to the Receiver. This can only work if the Receiver is able to set the Transmitter encryption key alongside the AP key, which not all chipsets do allow.

What is claimed is:

1. A method of efficient transmission of video stream via home 802.11 network bypassing the legacy Access point by using the multicast frames that are sent directly from the video transmission STA to the video reception STA and a device (the Transmitter) utilizing this method.

2. Method and device per claim 1, where the said frames are either not encrypted (if the home network uses no encryption), are encrypted using a WEP key with an index different from the default one (if the home network uses WEP encryption), or a group key with an unused index (if the home network uses WPA-PSK encryption).

3. A method of efficient transmission of video stream via home 802.11 network bypassing the legacy Access point by using the unicast frames that are sent directly from the video transmission STA to the video reception STA, similar to the DLP protocol, but not utilizing the AP for the configuration, and a device (the Transmitter) utilizing this method.
